(19) United States
(12) Patent Application Publication
(10) Pub. No.: US 2021/0328465 A1
(43) Pub. Date: Oct. 21, 2021

(54) Partitioned Stator

(71) Applicant: Zhe Jiang Cheering Sewing Machine Co., LTD., Lishui (CN)

(72) Inventors: Qianlin Zhao, Lishui (CN); Wen Liu, Lishui (CN); Qun Zhou, Lishui (CN); Yi Zhao, Lishui (CN); Xiuyu Guan, Lishui (CN); Qianli Huang, Lishui (CN); Bingping Fang, Lishui (CN); Qing Cheng, Lishui (CN)

(73) Assignee: Zhe Jiang Cheering Sewing Machine Co., LTD., Lishui (CN)

(21) Appl. No.: 16/983,336

(22) Filed: Aug. 3, 2020

(30) Foreign Application Priority Data
Apr. 17, 2020 (CN) 202010303550.6

(51) Int. Cl. H02K 1/14; H02K 1/16

(52) U.S. Cl. CPC H02K 1/148; H02K 2213/03; H02K 1/16

(57) ABSTRACT

Systems and methods of the present disclosure generally relate to a partitioned stator. The stator includes a plurality of partitioned iron cores that are identical in shape and connected to each other. Windings are wrapped around the partitioned iron cores. Each partitioned iron core includes a yoke and a tooth. End-face enlargements are symmetrically arranged on two end-faces of the yoke. The yoke is of an arc-shaped structure, and the end-face enlargements extend in a radial direction of the arc-shaped structure.

### TECHNICAL FIELD

The present disclosure relates to a partitioned stator, a motor with the partitioned stator, and an electric appliance or electric tool with the motor and the partitioned stator.

### BACKGROUND

A motor is widely applied in the technical fields of construction, electromechanical processing, and the like. A main structure of the motor includes a shell, a stator, and a rotor. The traditional motor may be manufactured by an integral stator stamping process. Drawbacks of the integral stator stamping process may include a low winding efficiency, and a low full rate of the winding groove. In addition, a utilization rate of a silicon steel sheet of the stator of the motor may be low, causing waste. These drawbacks may lead to low power density and torque density of the motor.

A partitioned stator can be wound independently such that the winding efficiency, the full rate of the winding groove, and the utilization rate of the silicon steel sheet of the motor stator can be improved. However, when the partitioned stators are spliced, due to a fracture distribution of the end faces of adjacent stator yokes, the partitioned stators may not be completely attached, leading to a formation of an air gap at the splicing position of the adjacent stator magnet yokes. The magnetic permeability of air and a silicon steel sheet are substantially different, which may lead to an increase of magnetic resistance at the splicing position of the magnet yokes of magnetic circuit channels of the motor, thereby affecting smoothness of the magnet yoke of the main channel of the magnetic potential energy of the motor, and causing magnetic leakage or magnetic potential loss.

Although these technical issues may be addressed by increasing the size of the stator; the increase in the size of the stator may cause the motor to be more cumbersome and may increase cost of production. Therefore, the traditional partitioned stator makes it difficult to increase the power density and torque density of the motor. Additionally, there may be issues in some applications that limit the size of the motor, such as an electric power tool, for example. Accordingly, improved motors may be desired.

### BRIEF DESCRIPTION OF THE DRAWINGS

These drawings illustrate certain aspects of some examples of the present disclosure and should not be used to limit or define the invention.

FIG. 1 illustrates a schematic view of a conventional stator having a partitioned iron core;

FIG. 2 illustrates a schematic view of a stator having a partitioned iron core, in accordance with particular embodiments of the present disclosure;

FIG. 3 illustrates a schematic view showing a structure in which an end-face enlargement is triangular, in accordance with particular embodiments of the present disclosure;

FIG. 4 illustrates a schematic view showing a structure in which an end-face enlargement is square, in accordance with particular embodiments of the present disclosure;

FIG. 5 illustrates a motor including the stator, in accordance with particular embodiments of the present disclosure; and

FIG. 6 illustrates an electric tool or appliance including the motor and the stator, in accordance with particular embodiments of the present disclosure.

### DETAILED DESCRIPTION

The present disclosure generally relates to a partitioned stator that may reduce magnetic chain and reluctance, reduce magnetic potential loss, and improve power density and torque density of the motor. The partitioned stator may be included in a motor, an electric appliance, or an electric tool, for example.

In order to achieve the objectives noted above, some embodiments of the present disclosure may include a partitioned stator comprising a plurality of partitioned iron cores that may be identical in shape and connected to each other. Windings may be wound or wrapped around the partitioned iron cores. Each partitioned iron core may include a yoke and a tooth. In some embodiments, end-face enlargements may be symmetrically arranged on two end-faces of the yoke. The yoke may be of an arc-shaped structure, and the end-face enlargements may extend in a radial direction of the arc-shaped structure.

The partitioned iron core may be formed by stacking or integrally forming a plurality of stator punching sheets. Each stator punching sheet may include an end-face enlargement. In certain embodiments, both ends of the yoke may extend inward to form the end-face enlargement. The end-face enlargement may be shaped as a sector, a triangle, or a square, for example. A length of the end face enlargement may be 1.05 to 1.2 times a cross-sectional length of an unexpanded portion of the yoke.

The end-face enlargement may provide compensation for a contact area of the adjacent partitioned iron cores, and the compensated contact area may fill the air gap generated by the fracture distribution of the metal end-face of the yoke of the traditional partitioned iron core, such that the magnetic leakage of the motor may be reduced without increasing the size of the motor, and the efficiency, the power density and the torque density of the motor are improved.

Additionally, the compensation area provided by the end-surface enlargement may also increase the area of the radial supporting surface of the adjacent yokes, and may reduce the overall circular distortion of the motor when the partitioned iron cores are spliced, such that the torque pulsation, vibration, and noise of the motor are reduced, and the motor operates with improved stability.

In certain embodiments, an electrical appliance may include the motor which may include the partitioned stator. In some embodiments, an electric tool, such as an angle grinder, may include the motor. By setting a compensation area, the motor may have higher torque density, power density, and efficiency, such that a size of the motor may be reduced, and the blade may be directly driven, thereby reducing power transmission loss and abrasion, prolonging a service life, reducing a diameter of a handle, and enhancing comfort of the handle.

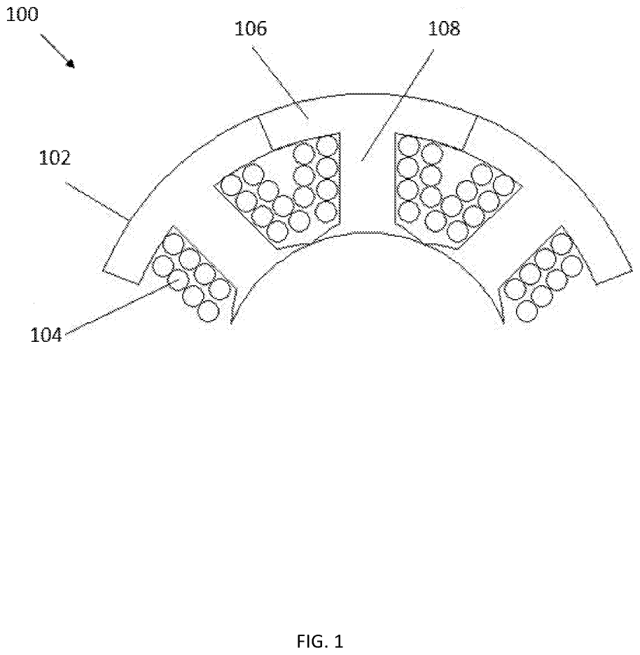

FIG. 1 illustrates a schematic view of a stator 100 formed by splicing conventional partitioned iron cores 102. The stator 100 may also include windings 104, yokes 106, and teeth 108, as illustrated.

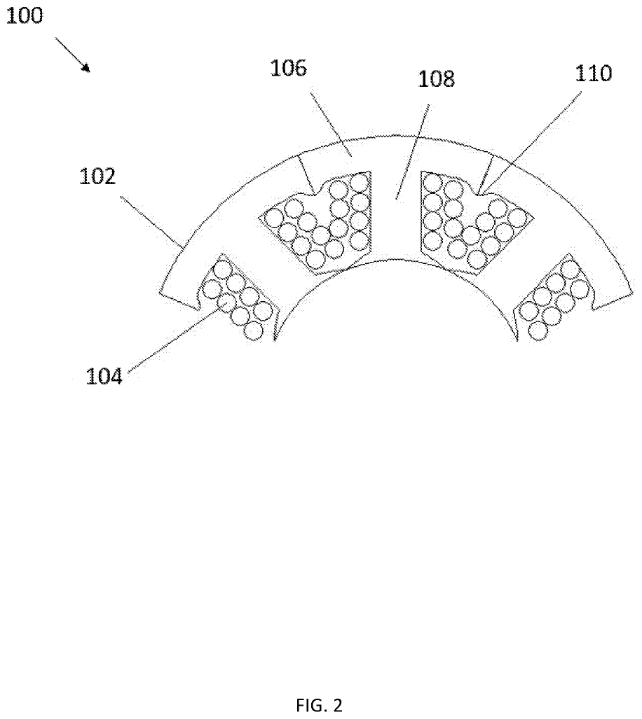

FIG. 2 illustrates the stator 100 including a plurality of partitioned iron cores 102 that are identical in shape and connected to each other, in accordance with embodiments of the present disclosure. The windings 104 may be wrapped around the partitioned iron cores 102. Each partitioned iron core 102 may include a yoke 106 and a tooth 108, and end-face enlargements 110 that may be symmetrically arranged on two end-faces of the yoke 106. The yoke 106 may be of an arc-shaped structure, and the end-face enlargements 110 may extend in a radial direction of the arc-shaped structure.

The end-face enlargements 110 of the yoke 106 may provide compensation for the contact area of the traditional adjacent partitioned iron cores 102 and may fill the air gap generated by fracture distribution of the metal end-face of the yoke 106 of the traditional partitioned iron core 102, such that magnetic leakage of a motor (not shown) may be reduced without increasing a size of the motor, and the efficiency, power density and torque density of the motor may be improved.

Additionally, the compensation area provided by the end-face enlargements 110 may increase an area of a radial supporting surface of adjacent yokes 106, and reduce an overall circular distortion of the motor when the partitioned iron cores 102 are spliced, thereby reducing torque pulsation, vibration and noise of the motor, as well as improving stability of the motor during operation.

Further, the partitioned iron cores 102 may be formed by stacking a plurality of stator punching sheets, or the partitioned iron cores 102 may be integrally formed by using soft magnetic materials. Each stator punching sheets may include an end-face enlargement 110. Both of these forming techniques should be understood by one having skill in the art, with the benefit of this disclosure.

In some embodiments, both ends of the yoke 106 may extend inward toward an arc to form the end-face enlargements 110. An extension direction of the end-face enlargements 110 may be determined according to actual use conditions. For example, in order to ensure that an outer surface of the spliced stator 100 is a circular surface for the stator 100 to be mounted in a motor housing (not shown), the end-face enlargements 110 may extend inward and/or outward in an arc-shaped radial direction depending on placement of the stator 100 in the motor housing.

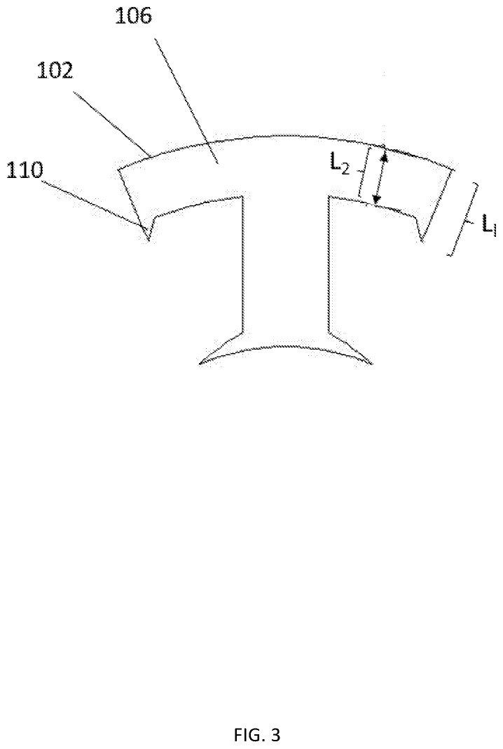

FIG. 3 illustrates the end-face enlargements 110 including a triangle shape to increase the contact area of each partitioned iron core 102, in accordance with embodiments of the present disclosure. A length, L₁, of each end-face enlargement 110 may range from 1.05 to 1.2 times a cross-sectional length, L₂, of an unexpanded portion of each yoke 106; and a specific multiple may be determined according to a flattening condition of an end-face of the partitioned iron core 102, and a length of the end-face enlargement 110 may not affect a normal winding of the partitioned iron core 102.

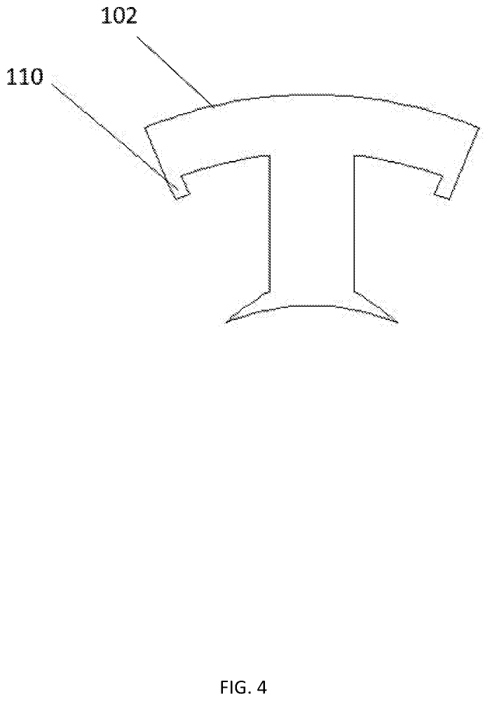

FIG. 4 illustrates the end-face enlargements 110 including a square shape to increase the contact area of each partitioned iron core 102, in accordance with embodiments of the present disclosure. Although not illustrated, the end-face enlargements 110 may include a fan shape, or any other shape configured to increase the contact area of each partitioned iron core 102.

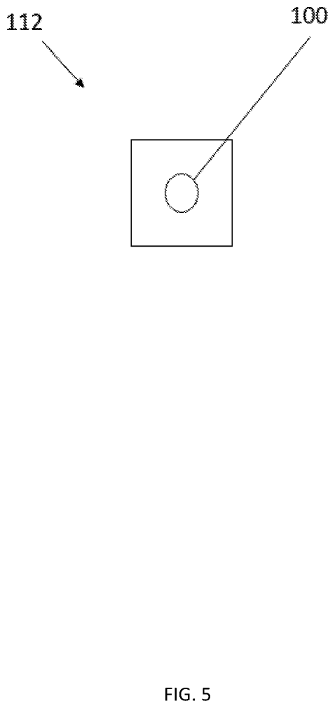

FIG. 5 illustrates a motor 112 including the stator 100, in accordance with some embodiments of the present disclosure. The motor 112 may be utilized within various electric tools or appliances, as should be understood by one having skill in the art, with the benefit of this disclosure.

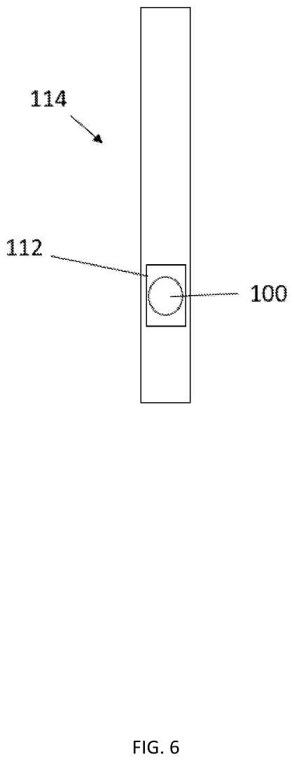

FIG. 6 illustrates an electric tool or appliance 114 including the motor 112 and the stator 100, in accordance with some embodiments of the present disclosure. A non-limiting example of the tool or appliance 114 may include an angle grinder.

The principles and embodiments of the present disclosure have been described herein with specific examples, which are presented to aid in the understanding of the methods and core concepts of the present disclosure. In addition, those skilled in the art can make various modifications in terms of the detailed description and the scope of application in accordance with the teachings of the present disclosure. In summary, the description shall not be construed as a limitation to the present disclosure.

What is claimed is:

1. A stator comprising:
a plurality of partitioned iron cores that are identical in shape and connected to each other; and
windings wrapped around the partitioned iron cores, wherein each partitioned iron core comprises a yoke and a tooth;
wherein end-face enlargements are symmetrically arranged on two end-faces of the yoke;
wherein the yoke is an arc-shaped structure; and
wherein the end-face enlargements extend in a radial direction of the arc-shaped structure.

2. The stator of claim 1, wherein each partitioned iron core is formed by stacking or integrally forming a plurality of stator punching sheets, wherein each stator punching sheet includes an end-face enlargement.

3. The stator of claim 1, wherein both end-faces of the yoke extend inward to form an end-face enlargement.

4. The stator of claim 3, wherein the end-face enlargement has a shape of a sector, a triangle, or a square.

5. The stator of claim 4, wherein a length of the end-face enlargement is 1.05 to 1.2 times a cross-sectional length of an unexpanded portion of the yoke.

6. A motor comprising:
a stator comprising:
a plurality of partitioned iron cores that are identical in shape and connected to each other; and
windings wrapped around the partitioned iron cores, wherein the partitioned iron cores each comprise a yoke and a tooth;
wherein end-face enlargements are symmetrically arranged on two end-faces of the yoke;
wherein the yoke is an arc-shaped structure; and
wherein the end-face enlargements extend in a radial direction of the arc-shaped structure.

7. The motor of claim 6, wherein each partitioned iron core is formed by stacking or integrally forming a plurality of stator punching sheets, wherein each stator punching sheet includes an end-face enlargement.

8. The motor of claim 6, wherein both end-faces of the yoke extend inward to form an end-face enlargement.

9. The motor of claim 8, wherein the end-face enlargement has a shape of a sector, a triangle, or a square.

10. The motor of claim 9, wherein a length of the end-face enlargement is 1.05 to 1.2 times a cross-sectional length of an unexpanded portion of the yoke.

11. An electric appliance comprising:
a motor comprising:
a stator comprising:
a plurality of partitioned iron cores that are identical in shape and connected to each other; and
windings wrapped around the partitioned iron cores, wherein the partitioned iron cores each comprise a yoke and a tooth;
wherein end-face enlargements are symmetrically arranged on two end-faces of the yoke;
wherein the yoke is an arc-shaped structure; and
wherein the end-face enlargements extend in a radial direction of the arc-shaped structure.

12. The electric appliance of claim 11, wherein each partitioned iron core is formed by stacking or integrally forming a plurality of stator punching sheets, wherein each stator punching sheet includes an end-face enlargement.

13. The electric appliance of claim 12, wherein both end-faces of the yoke extend inward to form an end-face enlargement.

14. The electric appliance of claim 13, wherein the end-face enlargement has a shape of a sector, a triangle, or a square.

15. The electric appliance of claim 14, wherein a length of the end-face enlargement is 1.05 to 1.2 times a cross-sectional length of an unexpanded portion of the yoke.
